(19) United States
(12) Patent Application Publication
(10) Pub. No.: US 2025/0097961 A1
(43) Pub. Date: Mar. 20, 2025

(54) S-SSB TRANSMISSION IN MULTIPLE RESOURCE BLOCK SETS

(71) Applicant: Samsung Electronics Co., Ltd., Suwon-si (KR)

(72) Inventors: Hongbo Si, Allen, TX (US); Kyeongin Jeong, Allen, TX (US)

(21) Appl. No.: 18/820,105

(22) Filed: Aug. 29, 2024

Related U.S. Application Data
(60) Provisional application No. 63/538,359, filed on Sep. 14, 2023.
(60) Provisional application No. 63/659,564, filed on Jun. 13, 2024.

(51) Int. Cl. H04W 72/25; H04W 72/0446

(52) U.S. Cl. CPC H04W 72/25; H04W 72/0446

(57) ABSTRACT

Apparatuses and methods for sidelink synchronization signals and physical sidelink broadcast channel block (S-SSB) transmission in resource block (RB) sets. A method of a user equipment (UE) includes receiving a set of configurations and determining, based on the set of configurations, a sidelink (SL) bandwidth part (BWP), a resource pool in the SL BWP, a number of RB sets in the SL BWP, and a slot for a transmission of a S-SSB. The number of RB sets include one anchor RB set and one or more non-anchor RB sets. The method further includes attempting to transmit the S-SSB in the slot and at least in the anchor RB set, wherein a channel access procedure is performed on a channel that includes the anchor RB set; and attempting to transmit the S-SSB in the slot and in the one or more non-anchor RB sets only when the channel access procedure fails.

### CROSS-REFERENCE TO RELATED AND CLAIM OF PRIORITY

The present application claims priority under 35 U.S.C. § 119 (e) to U.S. Provisional Patent Application No. 63/538,359 filed on Sep. 14, 2023 and U.S. Provisional Patent Application No. 63/659,564 filed on Jun. 13, 2024, which are hereby incorporated by reference in their entirety.

### TECHNICAL FIELD

The present disclosure relates generally to wireless communication systems and, more specifically, the present disclosure is related to apparatuses and methods for sidelink synchronization signals and physical sidelink broadcast channel block (S-SSB, or S-SS/PSBCH block) transmissions in multiple resource block (RB) sets.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance. To meet the demand for wireless data traffic having increased since deployment of 4G communication systems, and to enable various vertical applications, 5G communication systems have been developed and are currently being deployed.

### SUMMARY

The present disclosure relates to S-SSB transmissions in multiple RB sets.

In one embodiment, a user equipment (UE) in a wireless communication system is provided. The UE includes a transceiver configured to receive a set of configurations and a processor operably coupled to the transceiver. The processor is configured to determine, based on the set of configurations, a sidelink (SL) bandwidth part (BWP); determine, based on the set of configurations, a resource pool in the SL BWP; determine, based on the set of configurations, a number of resource block (RB) sets in the SL BWP; and determine, based on the set of configurations, a slot for a transmission of a sidelink synchronization signals and physical sidelink broadcast channel (S-SS/PSBCH) block. The number of RB sets include one anchor RB set and one or more non-anchor RB sets. The transceiver is further configured to attempt to transmit the S-SS/PSBCH block in the slot and at least in the anchor RB set, wherein a channel access procedure is performed on a channel that includes the anchor RB set; and attempt to transmit the S-SS/PSBCH block in the slot and in the one or more non-anchor RB sets only, when the channel access procedure fails.

In another embodiment, a method of a UE in a wireless communication system is provided. The method includes receiving a set of configurations; determining, based on the set of configurations, a SL BWP; determining, based on the set of configurations, a resource pool in the SL BWP; and determining, based on the set of configurations, a number of RB sets in the SL BWP. The number of RB sets include one anchor RB set and one or more non-anchor RB sets. The method further includes determining, based on the set of configurations, a slot for a transmission of a S-SS/PSBCH block; attempting to transmit the S-SS/PSBCH block in the slot and at least in the anchor RB set, wherein a channel access procedure is performed on a channel that includes the anchor RB set; and attempting to transmit the S-SS/PSBCH block in the slot and in the one or more non-anchor RB sets only, when the channel access procedure fails.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrates an example of a wireless transmit and receive paths according to embodiments of the present disclosure;

FIG. 5 illustrates a diagram of example RB sets for S-SSB transmission according to embodiments of the present disclosure;

FIG. 6 illustrates a diagram of an example S-SSB transmission according to embodiments of the present disclosure;

FIG. 7 illustrates a flowchart of an example UE procedure for S-SSB transmission according to embodiments of the present disclosure; and

FIG. 8 illustrates a flowchart of another example UE procedure for S-SSB transmission according to embodiments of the present disclosure.

### DETAILED DESCRIPTION

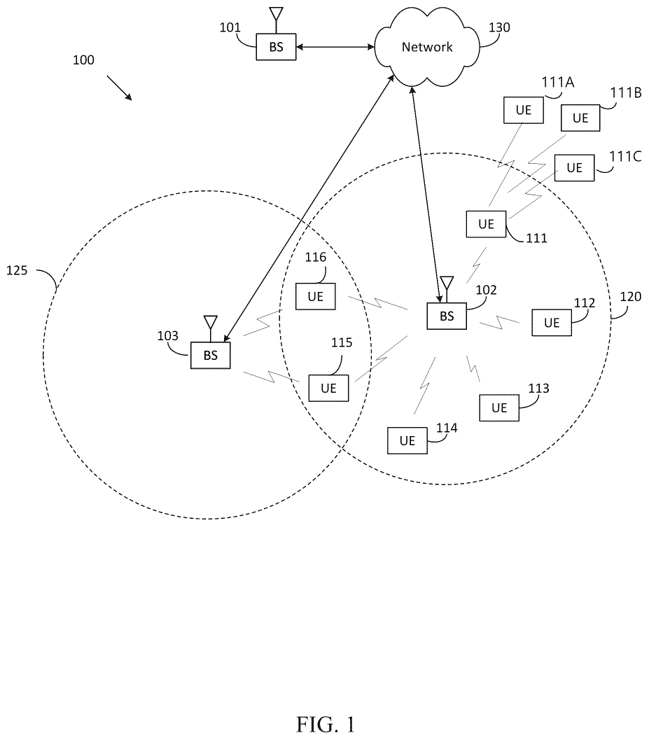

FIGS. 1-8, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents and standards descriptions are hereby incorporated by reference into the present disclosure as if fully set forth herein: [1] 3GPP TS 38.211 v17.1.0, “NR; Physical channels and modulation;” [2] 3GPP TS 38.212 v17.1.0, “NR; Multiplexing and channel coding;” [3] 3GPP TS 38.213 v17.1.0, “NR; Physical layer procedures for control;” [4] 3GPP TS 38.214 v17.1.0, “NR; Physical layer procedures for data;” and [5] 3GPP TS 38.331 v17.1.0, “NR; Radio Resource Control (RRC) protocol specification;”

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for performing S-SSB transmission in multiple RB sets. In certain embodiments, one or more of the BSs 101-103 include circuitry, programing, or a combination thereof for supporting S-SSB transmission in multiple RB sets.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

As discussed in greater detail below, the wireless network 100 may have communications facilitated via one or more devices (e.g., UEs 111A to 111C) that may have a SL communication with the UE 111. The UE 111 can communicate directly with the UEs 111A to 111C through a set of SLs (e.g., SL interfaces) to provide sideline communication, for example, in situations where the UEs 111A to 111C are remotely located or otherwise in need of facilitation for network access connections (e.g., BS 102) beyond or in addition to common fronthaul and/or backhaul connections/interfaces. In one example, the UE 111 can have direct communication, through the SL communication, with UEs 111A to 111C with or without support by the BS 102. Various of the UEs (e.g., as depicted by UEs 112 to 116) may be capable of one or more communication with their other UEs (such as UEs 111A to 111C as for UE 111).

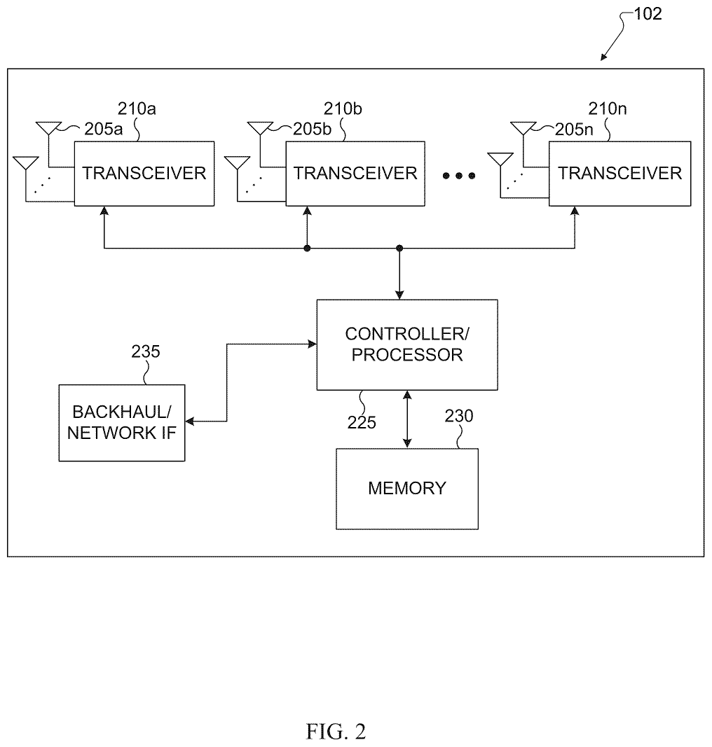

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for supporting S-SSB transmission in multiple RB sets. Any of a wide variety of other functions could be supported in the gNB 102 by the controller/processor 225.

The controller/processor 225 is also capable of executing programs and other processes resident in the memory 230. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

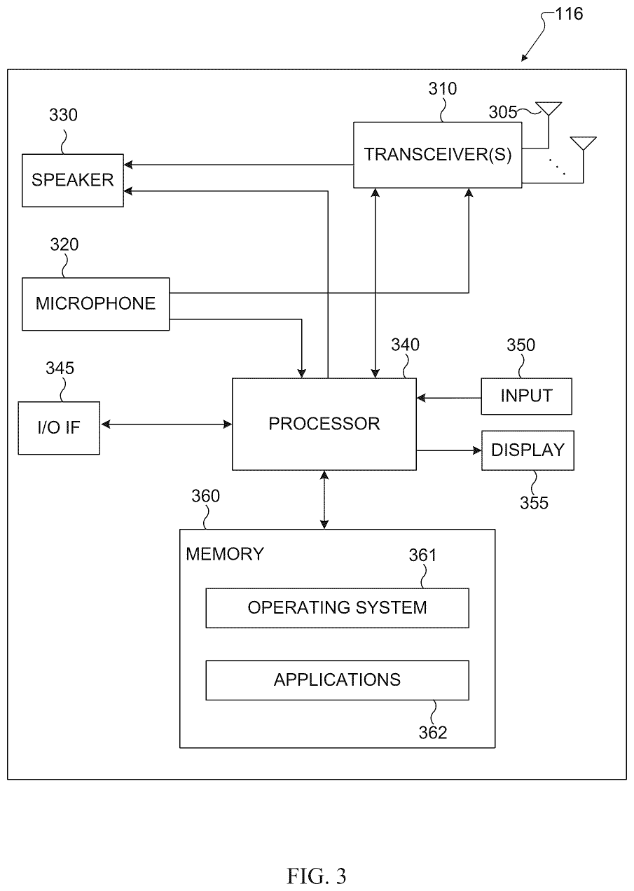

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the network 100 or by other UEs (e.g., one or more of UEs 111-115) on a SL channel. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL and/or SL channels and/or signals and the transmission of UL and/or SL channels and/or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for supporting or utilizing S-SSB transmission in multiple RB sets as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

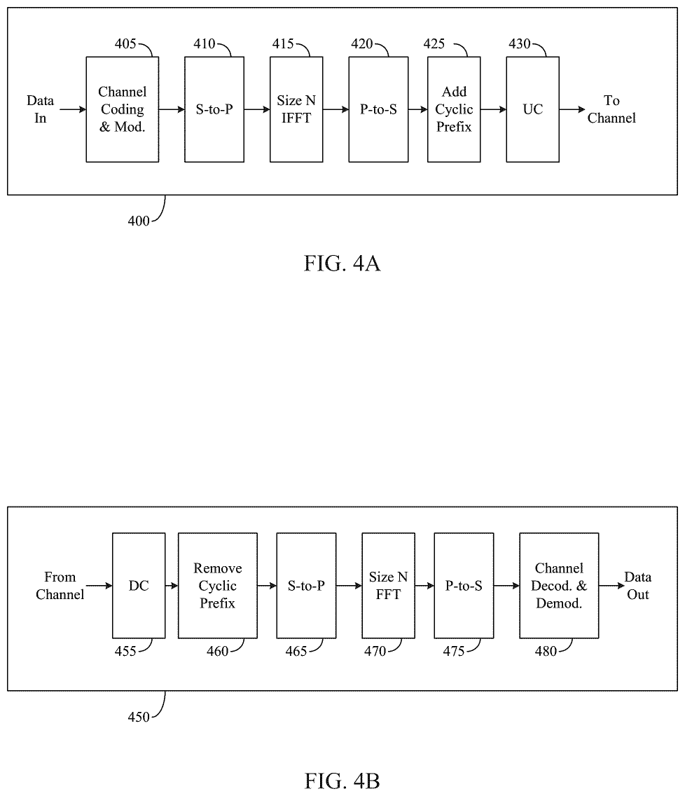

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. It may also be understood that the receive path 450 can be implemented in a first UE and that the transmit path 400 can be implemented in a second UE to support SL communications. In some embodiments, the transmit path 400 and/or receive path 450 is configured to support S-SSB transmission in multiple RB sets as described in embodiments of the present disclosure.

As illustrated in FIG. 4A, the transmit path 400 includes a channel coding and modulation block 205, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 250 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

For sidelink (SL) operating on unlicensed or shared spectrum, two types of channel access procedure can be supported, wherein one type of channel access procedure can be further classified into three sub-types.

In Type 1 SL channel access procedure, the time duration spanned by the sensing slots that are sensed to be idle before sidelink transmission(s) is random and based on a counter, wherein the channel access procedure is associated with a channel access priority class (e.g., p).

In Type 2 SL channel access procedure, the time duration spanned by the sensing slots that are sensed to be idle before sidelink transmission(s) is deterministic. In Type 2A SL channel access procedure, the time duration is deterministic as 25 us. In Type 2B SL channel access procedure, the time duration is deterministic as 16 us. In Type 2C SL channel access procedure, the time duration is deterministic as 0 us.

In common SL operation, a slot including a SL transmission may also be allocated for a SL reception. After the counter achieves 0 in the Type 1 channel access procedure, the UE may not transmit the SL transmission in the slot but perform the SL reception. For this scenario, enhancement to Type 1 channel access procedure is needed.

Also, for a slot with two starting locations for SL transmissions and for a transmission has multiple transmission occasions to choose from, channel access procedure(s) should also be enhanced to incorporate such flexibility in time domain.

Meanwhile, interaction between Type 1 and Type 2 channel access procedure should also be evaluated to support flexible and efficient channel access.

This disclosure provides improvements on the transmission of S-SSB over multiple RB sets on unlicensed band. More precisely, the issue of anchor RB-set outside the resource pool is provided. By way of example, the following methods are provided:
Anchor RB-set is confined within the RB set(s) associated with the resource pool;
Guaranteed S-SSB transmission in the anchor RB set;
Dropping S-SSB transmission in the RB sets;
Anchor RB set switching based on the resource pool; and
Allowing S-SSB transmission in the non-anchor RB set(s).

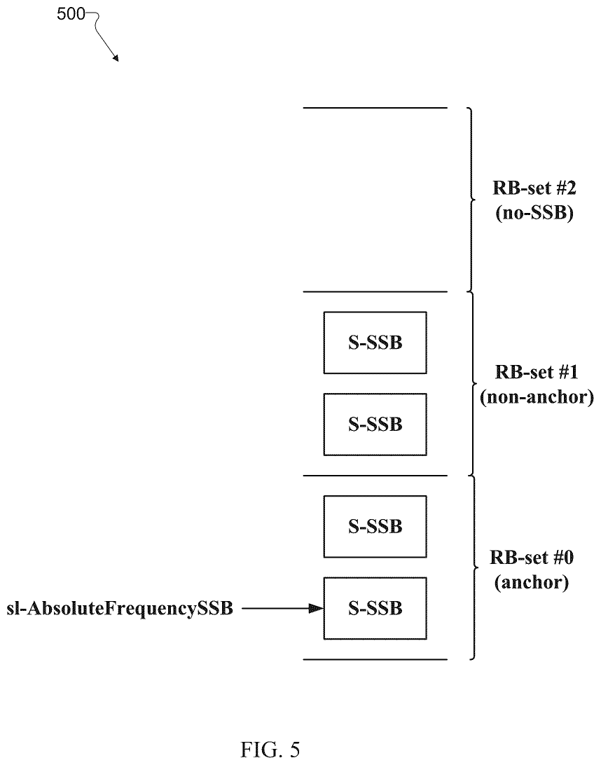

FIG. 5 illustrates a diagram of example RB sets 500 for S-SSB transmission according to embodiments of the present disclosure. For example, RB sets 500 for S-SSB transmission can be accessed by an of the UEs 111-111C, such as the UE 111A. This example is for illustration only and other embodiments can be used without departing from the scope of the present disclosure.

When a sidelink (SL) bandwidth part (BWP), which can be determined based on (pre-) configurations, includes multiple RB sets (e.g., also determined based on (pre-) configurations), a resource pool can be selected and/or (pre-) configured to be associated with a number of RB sets within the multiple RB sets. Meanwhile, a sidelink synchronization signal and physical sidelink broadcast channel block (S-SSB) can be transmitted in one or multiple RB sets within the multiple RB sets included in the SL BWP, according to (pre-) configurations for instance. Embodiments of the present disclosure recognize that, for those S-SSB transmissions on channel(s) with shared spectrum channel access, channel access procedure needs to be supported and the transmission behavior of the S-SSB in multiple RB sets also needs to be supported.

For one embodiment, the examples and methods of this disclosure can be applicable at least for operation with shared spectrum channel access on sidelink (e.g., sidelink unlicensed).

In this disclosure, with reference to FIG. 5, an anchor RB-set refers to the RB-set that includes the S-SSB with center frequency (pre-) configured by sl-AbsoluteFrequencySSB, and/or a non-anchor RB-set refers to a RB-set that includes the transmission occasions for S-SSB but not the anchor RB-set, wherein the transmission occasions can be determined based on (pre-) configurations, and/or a no-SSB RB-set refers to a RB-set that does not include the transmission occasions for S-SSB.

Meanwhile, in this disclosure, slot(s) including common S-SSB transmission occasions refer to the ones defined by N_{offset}^{S-SSB}+(Nᵢₙₜₑᵣᵥₐₗ^{S-SSB}+1)·i_{S-SSB}, where:
index 0 corresponds to a first slot in a frame with a system frame number (SFN) of the serving cell satisfying (SFN mod 16)=0 or a direct frame number (DFN) satisfying (DFN mod 16)=0.
i_{S-SSB} is a S-SS/PSBCH block index within the number of S-SS/PSBCH blocks in the period, with 0≤i_{S-SSB}≤N_{period}^{S-SSB}−1 and N_{period}^{S-SSB} is provided by sl-NumSSB-WithinPeriod.
N_{offset}^{S-SSB} is a slot offset from a start of the period to the first slot including S-SS/PSBCH block, provided by sl-TimeOffsetSSB.
Nᵢₙₜₑᵣᵥₐₗ^{S-SSB} is a slot interval between sidelink synchronization signals/physical sidelink broadcast channel (S-SS/PSBCH) blocks, provided by sl-TimeInterval.

Moreover, in this disclosure, slot(s) including additional candidate S-SSB transmission occasions refer to the ones defined by N_{offset}^{S-SSB}+(Nᵢₙₜₑᵣᵥₐₗ^{S-SSB}+1)·i_{S-SSB}+N_{gap}^{S-SSB}·(ī_{S-SSB}+1), where:
N_{gap}^{S-SSB} is a slot gap for determining the additional candidate S-SS/PBCH block transmission occasions, provided by sl-TimeGapAdditionalOccasion.
ī_{S-SSB} is an index of the additional candidate S-SS/PBCH block transmission occasions, with 0≤ī_{S-SSB}≤N_{additional}^{S-SSB}−1, and N_{additional}^{S-SSB} is provided by a (pre-) configuration.

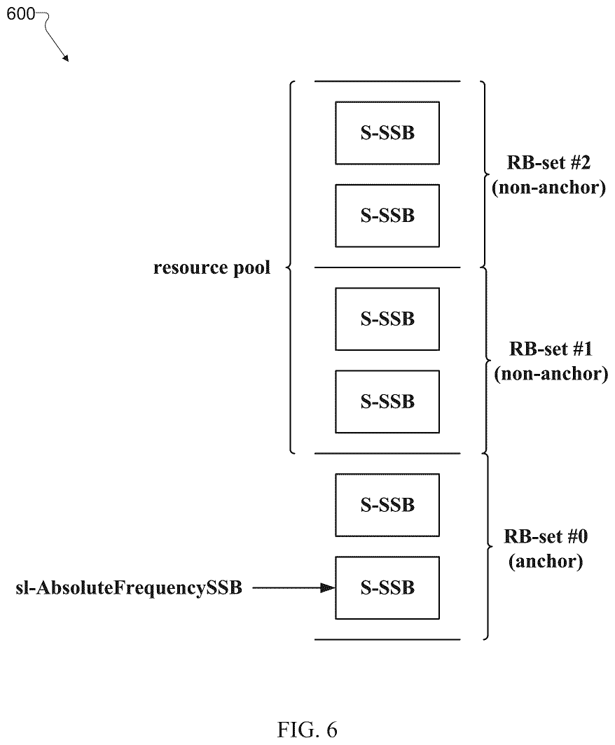

FIG. 6 illustrates a diagram of an example S-SSB transmission 600 according to embodiments of the present disclosure. For example, S-SSB transmission 600 can be transmitted by any of the UEs 111-111C of FIG. 1, such as the UE 111B. This example is for illustration only and other embodiments can be used without departing from the scope of the present disclosure.

An anchor RB-set can be outside the bandwidth of a resource pool. For example, with reference to FIG. 6, such scenario can happen when the anchor RB-set is not (pre-) configured as part of the resource pool in the frequency domain (e.g., due to consistent listen-before-talk (LBT) failure on the anchor RB-set).

For one embodiment, at least one of the UE behaviors according to one or more examples of this disclosure can be supported. For one instance, when multiple UE behaviors are supported, a (pre-) configuration can be supported to indicate which UE behavior to use. For another instance, when multiple UE behaviors are supported, it's up to UE's implementation which UE behavior to use.

In one embodiment, a UE (e.g., the UE 111) can expect the RB-set(s) associated with a resource pool to include the anchor RB-set. For example, such UE behavior can be achieved by the proper (pre-) configuration of the resource pool in selection and/or reselection of the resource pool.

For one example, the UE can attempt to transmit the S-SSB(s) at least in the anchor RB-set in the frequency domain.
For one instance, for a set of slot(s) that a UE determines to attempt to transmit S-SSB(s), wherein the set of slot(s) includes at least the slot(s) including the common S-SSB transmission occasions, the UE at least attempts to transmit S-SSB(s) in the anchor RB-set.
For another instance, the UE at least attempts to transmit S-SSB(s) in the anchor RB-set and in the slot(s) including the common S-SSB transmission occasions.

For another example, the UE can also attempt to transmit the S-SSB(s) in the non-anchor RB-set(s) within the RB-set(s) associated with the resource pool.

For yet another example, the UE may not attempt to transmit the S-SSB(s) in a non-anchor RB-set outside the RB-set(s) associated with the resource pool.

In one embodiment, at least when a resource pool does not include the anchor RB-set, the UE can attempt to transmit the S-SSB(s) at least in the anchor RB-set in the frequency domain. Further, this embodiment can be applicable when the resource pool includes the anchor RB-set as well.

For one example, this embodiment is applicable at least when the S-SSB(s) transmission is within a slot with common S-SSB transmission occasions (e.g., not the additional candidate S-SSB transmission occasions).
For one instance, for a set of slot(s) that a UE determines to attempt to transmit S-SSB(s), wherein the set of slot(s) includes at least the slot(s) including the common S-SSB transmission occasions, the UE at least attempts to transmit S-SSB(s) in the anchor RB-set.
For another instance, the UE at least attempts to transmit S-SSB(s) in the anchor RB-set and in the slot(s) including the common S-SSB transmission occasions.

For another example, this embodiment is applicable when the S-SSB(s) transmission is within a slot with common S-SSB transmission occasions (e.g., not the additional candidate S-SSB transmission occasions).
For one instance, for the slot(s) including the common S-SSB transmission occasions, the UE at least attempts to transmit S-SSB(s) in the anchor RB-set.

For yet another example, when performing the S-SSB(s) transmission on at least in the anchor RB-set, a Type 1 or Type 2A (when the duty cycle and duration satisfy the condition as in the example of this disclosure) channel access procedure can be performed to initiate a channel occupancy over at least the anchor RB-set. The UE performs the transmission for S-SSB(s) at least in the anchor RB-set if the channel access procedure is successfully performed.

For yet another example, the UE may not attempt to transmit the S-SSB(s) at least in a non-anchor RB-set within the RB-set(s) associated with the resource pool.
For one instance, if the UE has already initiated a channel occupancy on one or multiple of the non-anchor RB-set(s) within the RB-set(s) associated with the resource pool and started SL transmission within the channel occupancy in the slots right before the slot for S-SSB(s) transmission, the UE may terminate the channel occupancy by not attempting to transmit the S-SSB(s). If there is further SL transmission(s) in the slot(s) right after the slot for S-SSB(s) transmission on the one or multiple of the non-anchor RB-set(s) within the RB-set(s) associated with the resource pool, the UE may need to perform a Type 1 channel access procedure (for one non-anchor RB-set case) or multi-channel access procedure (for multiple non-anchor RB sets case) to initiate a new channel occupancy for perform the further SL transmission(s), if the sensing in the channel access procedure is idle.
For another instance, if the UE has already initiated a channel occupancy on one or multiple of the non-anchor RB-set(s) within the RB-set(s) associated with the resource pool and started SL transmission within the channel occupancy in the slots right before the slot for S-SSB(s) transmission, the UE may suspend the channel occupancy by not attempting to transmit the S-SSB(s). If there is further SL transmission(s) in the slot(s) right after the slot for S-SSB(s) transmission on the one or multiple of the non-anchor RB-set(s) within the RB-set(s) associated with the resource pool, the UE may need to perform contiguous sensing and a Type 2A channel access procedure immediately before the further SL transmission(s) to resume the channel occupancy for perform the further SL transmission(s), if the sensing is idle.

For yet another example, the UE can attempt to transmit the S-SSB(s) in a set of RB-set(s) including the anchor RB-set.
For one instance, a multi-channel access procedure can be performed over the set of RB-set(s) to initiate a channel occupancy for the S-SSB(s) transmission, e.g., the multi-channel access procedure is performed over the set of RB-set(s) including the anchor RB-set.

In one embodiment, when a resource pool does not include the anchor RB-set, the UE can drop the S-SSB(s) transmission in the slot for S-SSB(s) transmission.

For one example, this embodiment can be applicable when the S-SSB(s) transmission is within a slot including the additional candidate S-SSB transmission occasions (e.g., not the common S-SSB transmission occasions).
For one instance, when a resource pool does not include the anchor RB-set, for the slot(s) including the additional candidate S-SSB transmission occasions, the UE can drop the S-SSB transmission in the slot(s).

In one embodiment, when a resource pool does not include the anchor RB-set, the UE may expect a new anchor RB-set wherein the new anchor RB-set can be determined from the RB-set(s) associated with the resource pool.

For one example, the new anchor RB-set is selected from RB-set(s) including transmission occasions for S-SSB (e.g., non-anchor RB-set).

For another example, the new anchor RB-set can be (pre-) configured.
For one instance, the (pre-) configuration can be based on a frequency location of a S-SSB in the new anchor RB-set.
For another instance, the (pre-) configuration can be based on an RB-set index.
For yet another instance, the (pre-) configuration can be associated with the (pre-) configuration for the resource pool.

For yet another example, the new anchor RB-set can be determined by the UE.
For one instance, the new anchor RB-set can be the RB-set with lowest RB-set index within the RB-set(s) associated with the resource pool and/or including S-SSB transmission occasions (e.g., the non-anchor RB-set with lowest RB-set index within the non-anchor RB-set(s) associated with the resource pool).
For another instance, the new anchor RB-set can be the RB-set with lowest RB-set index within the RB-set(s) associated with the resource pool.
For yet another instance, the new anchor RB-set can be the RB-set with highest RB-set index within the RB-set(s) associated with the resource pool and/or including S-SSB transmission occasions (e.g., the non-anchor RB-set with highest RB-set index within the non-anchor RB-set(s) associated with the resource pool).
For yet another instance, the new anchor RB-set can be the RB-set with highest RB-set index within the RB-set(s) associated with the resource pool.
For yet another instance, the new anchor RB-set can be the closest RB-set comparing to the original anchor RB-set within the RB-set(s) associated with the resource pool and/or including S-SSB transmission occasions (e.g., the closest non-anchor RB-set comparing to the original anchor RB-set within the non-anchor RB-set(s) associated with the resource pool); further for this sub-instance, when there is a tie, the new anchor RB-set can be the one with lower or higher RB-set index.
For yet another instance, the new anchor RB-set can be the closest RB-set comparing to the original anchor RB-set within the RB-set(s) associated with the resource pool; further for this sub-instance, when there is a tie, the new anchor RB-set can be the one with lower or higher RB-set index.

For one example, the UE can attempt to transmit the S-SSB(s) at least in the new anchor RB-set in the frequency domain.
For one instance, for a set of slot(s) that a UE determines to attempt to transmit S-SSB(s), wherein the set of slot(s) includes at least the slot(s) including the common S-SSB transmission occasions, the UE at least attempts to transmit S-SSB(s) in the anchor RB-set.
For another instance, the UE at least attempts to transmit S-SSB(s) in the anchor RB-set and in the slot(s) including the common S-SSB transmission occasions.

For another example, the UE can also attempt to transmit the S-SSB(s) in the non-anchor RB-set(s) within the RB-set(s) associated with the resource pool.

For yet another example, the UE may not attempt to transmit the S-SSB(s) in a non-anchor RB-set outside the RB-set(s) associated with the resource pool (e.g., the non-anchor RB-set may be the original anchor RB-set).

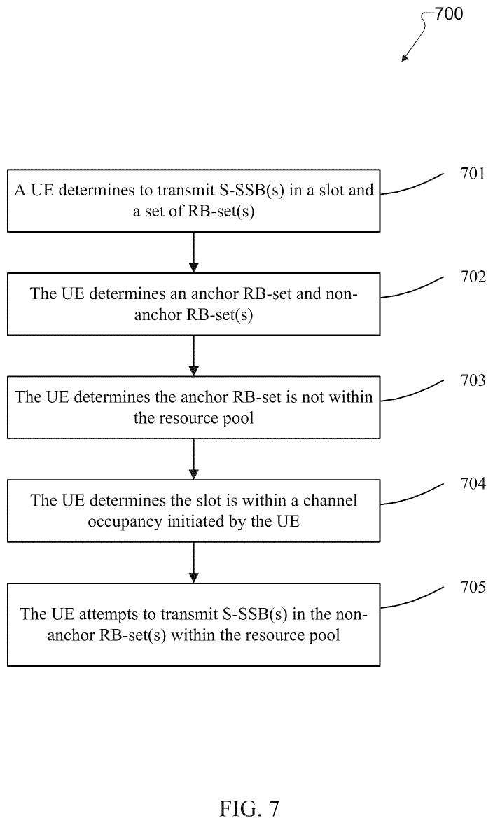

FIG. 7 illustrates a flowchart of an example UE procedure 700 for S-SSB transmission according to embodiments of the present disclosure. For example, UE procedure 700 for S-SSB transmission can be performed by any of the UEs 111-111C, such as the UE 111C. This example is for illustration only and other embodiments can be used without departing from the scope of the present disclosure.

The procedure begins in 701, a UE determines to transmit S-SSB(s) in a slot and a set of RB-set(s). In 702, the UE determines an anchor RB-set and non-anchor RB-set(s). In 703, the UE determines the anchor RB-set is not within the resource pool. In 704, the UE determines the slot is within a channel occupancy initiated by the UE. In 705, the UE attempts to transmit S-SSB(s) in the non-anchor RB-set(s) within the resource pool.

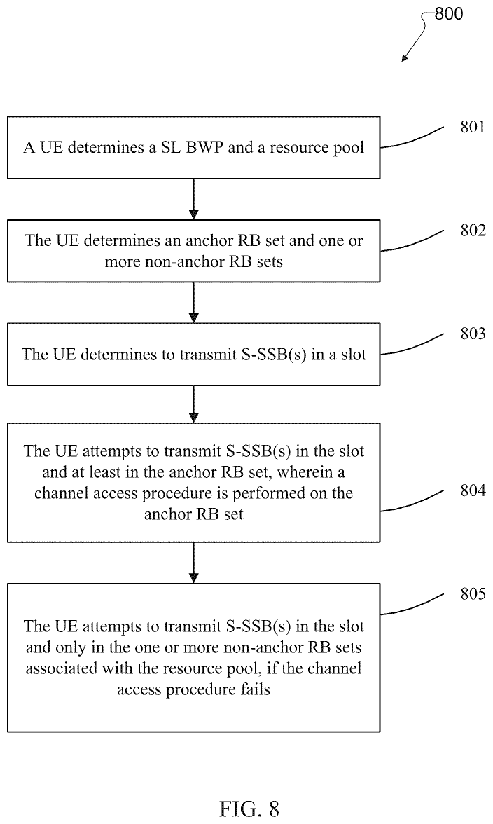

FIG. 8 illustrates a flowchart of another example UE procedure 800 for S-SSB transmission according to embodiments of the present disclosure. For example, UE procedure 800 for S-SSB transmission can be performed by any of the UEs 111-111C, such as the UE 111C. This example is for illustration only and other embodiments can be used without departing from the scope of the present disclosure.

The procedure begins in 801, where a UE determines a SL BWP and a resource pool. In 802, the UE determines an anchor RB set and one or more non-anchor RB sets. In 803, the UE determines to transmit S-SSB(s) in a slot. In 804, the UE attempts to transmit S-SSB(s) in the slot and at least in the anchor RB set, wherein a channel access procedure is performed on the anchor RB set. In 805, the UE attempts to transmit S-SSB(s) in the slot and only in the one or more non-anchor RB sets associated with the resource pool, if the channel access procedure fails.

In one embodiment, at least when the RB-set(s) corresponding to a resource pool does not include the anchor RB-set, a UE can attempt to transmit S-SSB(s) in non-anchor RB-set(s) within the RB-set(s) associated with the resource pool (e.g., not including the anchor RB-set).

For one example, this embodiment is applicable in addition to the UE behavior that the UE (e.g., the UE 111) can attempt to transmit S-SSB(s) at least in the anchor RB-set, as described in this disclosure.
For one instance, there can be a (pre-) configuration to determine which UE behaviour to use.
For another instance, it is up to UE implementation to choose which UE behaviour to use.
For yet another instance, it is applicable if the attempt to transmit S-SSB(s) at least in the anchor RB-set fails, e.g., the channel access procedure for transmit S-SSB(s) on the channel that includes the anchor RB-set fails.

For another example, this embodiment is applicable at least when the S-SSB(s) transmission is within a slot with common S-SSB transmission occasions (e.g., not the additional candidate S-SSB transmission occasions).

For yet another example, this embodiment can be applicable at least when the S-SSB(s) transmission is within a slot including the additional candidate S-SSB transmission occasions (e.g., not the common S-SSB transmission occasions).

For yet another example, this embodiment can be applicable when the slot for S-SSB(s) transmission is within a channel occupancy initiated by the UE. Further, at least one of the following sub-examples can be applicable to further describe the S-SSB(s) transmission within the channel occupancy.
For one sub-example, the S-SSB(s) is not the first transmission in the channel occupancy.
For another sub-example, the slot for S-SSB transmission is right after slot(s) for a SL transmission (e.g., physical sidelink shared channel (PSSCH)/physical sidelink control channel (PSCCH) and/or physical sidelink feedback channel (PSFCH)) from the same UE in the channel occupancy.
For yet another sub-example, the slot for S-SSB transmission is right before slot(s) for a further SL transmission (e.g., PSSCH/PSCCH and/or PSFCH) from the same UE in the channel occupancy.

For yet another example, the power allocated for the S-SSB(s) attempted to be transmitted in the non-anchor RB-set(s) can be determined as equal, and the total power for the S-SSB(s) attempted to be transmitted is determined as the remaining power from a maximum transmission power (PCMAX) (if any remains available) after allocating power for the S-SSB(s) hypothetically attempted to be transmitted in the anchor RB-set(s).

For yet another example, the power allocated for the S-SSB(s) in the non-anchor RB-set(s) is determined as equal. The total power for the S-SSB(s) attempted to be transmitted is determined as the remaining power from PCMAX (if any remains available) after allocating power for the S-SSB(s) in the anchor RB-set(s). For this instance, the S-SSB(s) refer to the ones subject to the (pre-) configuration, regardless of whether the S-SSB(s) are attempted to be transmitted.

For yet another example, the power allocated for the S-SSB(s) attempted to be transmitted in the non-anchor RB-set(s) is determined as equal. The total power for the S-SSB(s) attempted to be transmitted can be based on a (pre-) configuration. For one sub-instance, there can be a (pre-) configuration on the power offset, wherein the power offset is 0 when the S-SSB(s) in anchor RB-set is not transmitted.

For yet another example, for a set of slot(s) that a UE determines to attempt to transmit S-SSB(s), wherein the set of slot(s) includes at least the slot(s) including the common S-SSB transmission occasions (and may also include the slot(s) including the additional S-SSB transmission occasions if the UE decides to transmit on the additional S-SSB transmission occasions), the UE at least attempts to transmit S-SSB(s) in the anchor RB-set; when at least one of the following further conditions is satisfied, the UE can attempt to transmit S-SSB(s) in non-anchor RB-set(s) (not transmit S-SSB(s) in the anchor RB-set):
Condition 1: the anchor RB-set is not within the RB-set(s) associated with the resource pool;
Condition 2: the non-anchor RB-set(s) are within the RB-set(s) associated with the resource pool;
Condition 3: the slot including the S-SSB transmission includes the common S-SSB transmission occasions (e.g., not the additional candidate S-SSB transmission occasions);
Condition 4: the slot for S-SSB(s) transmission is within a channel occupancy initiated by the UE (optionally with further sub-example applied according to the example of this disclosure). For instance, SL transmission (e.g., PSSCH/PSCCH and/or PSFCH) can occur right before the slot for S-SSB(s) transmission;
Condition 5: the non-anchor RB-set(s) for S-SSB(s) transmission is within a channel occupancy initiated by the UE (potentially with further sub-example applied according to the example of this disclosure). For instance, SL transmission (e.g., PSSCH/PSCCH and/or PSFCH) can occur in the non-anchor RB-set(s); and/or
Condition 6: the channel access procedure for transmit S-SSB(s) on the channel that includes the anchor RB-set fails. For instance, the channel access procedure can be one of a Type 1 SL channel access procedure or a Type 2A SL channel access procedure (when the duty cycle and duration satisfy the condition as in the example of this disclosure).

For yet another example, for a set of slot(s) that a UE determines to attempt to transmit S-SSB(s), wherein the set of slot(s) includes at least the slot(s) including the common S-SSB transmission occasions (and may also include the slot(s) including the additional S-SSB transmission occasions if the UE decides to transmit on the additional S-SSB transmission occasions), the UE at least attempts to transmit S-SSB(s) in the anchor RB-set; and when at least one of the following conditions is satisfied, the UE can attempt to transmit S-SSB(s) in non-anchor RB-set(s) (not transmit S-SSB(s) in the anchor RB-set):
Condition 1: the anchor RB-set is not within the RB-set(s) associated with the resource pool;
Condition 2: the non-anchor RB-set(s) are within the RB-set(s) associated with the resource pool;
Condition 3: the slot including the S-SSB transmission includes the additional candidate S-SSB transmission occasions (e.g., not the common S-SSB transmission occasions);
Condition 4: the slot for S-SSB(s) transmission is within a channel occupancy initiated by the UE (optionally with further sub-example applied according to the example of this disclosure). For instance, SL transmission (e.g., PSSCH/PSCCH and/or PSFCH) can occur right before the slot for S-SSB(s) transmission.
Condition 5: the non-anchor RB-set(s) for S-SSB(s) transmission is within a channel occupancy initiated by the UE (potentially with further sub-example applied according to the example of this disclosure). For instance, SL transmission (e.g., PSSCH/PSCCH and/or PSFCH) can occur in the non-anchor RB-set(s).
Condition 6: the channel access procedure for transmit S-SSB(s) on the channel that includes the anchor RB-set fails. For instance, the channel access procedure can be one of a Type 1 SL channel access procedure or a Type 2A SL channel access procedure (when the duty cycle and duration satisfy the condition as in the example of this disclosure).

For yet another example, for a set of slot(s) that a UE determines to attempt to transmit S-SSB(s), wherein the set of slot(s) includes at least the slot(s) including the common S-SSB transmission occasions (and may also include the slot(s) including the additional S-SSB transmission occasions if the UE decides to transmit on the additional S-SSB transmission occasions), when at least one of the following further conditions is satisfied, the UE can attempt to transmit S-SSB(s) in non-anchor RB-set(s) (not transmit S-SSB(s) in the anchor RB-set); otherwise, the UE at least attempts to transmit S-SSB(s) in the anchor RB-set:
Condition 1: the anchor RB-set is not within the RB-set(s) associated with the resource pool;
Condition 2: the non-anchor RB-set(s) are within the RB-set(s) associated with the resource pool;
Condition 3: the slot including the S-SSB transmission includes the common S-SSB transmission occasions (e.g., not the additional candidate S-SSB transmission occasions);
Condition 4: the slot for S-SSB(s) transmission is within a channel occupancy initiated by the UE (potentially with further sub-example applied according to the example of this disclosure). For instance, SL transmission (e.g., PSSCH/PSCCH and/or PSFCH) can occur right before the slot for S-SSB(s) transmission.
Condition 5: the non-anchor RB-set(s) for S-SSB(s) transmission is within a channel occupancy initiated by the UE (potentially with further sub-example applied according to the example of this disclosure). For instance, SL transmission (e.g., PSSCH/PSCCH and/or PSFCH) can occur in the non-anchor RB-set(s).
Condition 6: the channel access procedure for transmit S-SSB(s) on the channel that includes the anchor RB-set fails. For instance, the channel access procedure can be one of a Type 1 SL channel access procedure or a Type 2A SL channel access procedure (when the duty cycle and duration satisfy the condition as in the example of this disclosure).

For yet another example, for a set of slot(s) that a UE determines to attempt to transmit S-SSB(s), wherein the set of slot(s) includes at least the slot(s) including the common S-SSB transmission occasions (and may also include the slot(s) including the additional S-SSB transmission occasions if the UE decides to transmit on the additional S-SSB transmission occasions), when at least one of the following conditions is satisfied, the UE can attempt to transmit S-SSB(s) in non-anchor RB-set(s) (not transmit S-SSB(s) in the anchor RB-set); otherwise, the UE at least attempts to transmit S-SSB(s) in the anchor RB-set:
Condition 1: the anchor RB-set is not within the RB-set(s) associated with the resource pool;
Condition 2: the non-anchor RB-set(s) are within the RB-set(s) associated with the resource pool;
Condition 3: the slot including the S-SSB transmission includes the additional candidate S-SSB transmission occasions (e.g., not the common S-SSB transmission occasions); and/or
Condition 4: the slot for S-SSB(s) transmission is within a channel occupancy initiated by the UE (optionally with further sub-example applied according to the example of this disclosure). For instance, SL transmission (e.g., PSSCH/PSCCH and/or PSFCH) can occur right before the slot for S-SSB(s) transmission.
Condition 5: the non-anchor RB-set(s) for S-SSB(s) transmission is within a channel occupancy initiated by the UE (potentially with further sub-example applied according to the example of this disclosure). For instance, SL transmission (e.g., PSSCH/PSCCH and/or PSFCH) can occur in the non-anchor RB-set(s).
Condition 6: the channel access procedure for transmit S-SSB(s) on the channel that includes the anchor RB-set fails. For instance, the channel access procedure can be one of a Type 1 SL channel access procedure or a Type 2A SL channel access procedure (when the duty cycle and duration satisfy the condition as in the example of this disclosure).

For yet another example, the UE at least attempts to transmit S-SSB(s) in the anchor RB-set and in the slot(s) including the common S-SSB transmission occasions; and when at least one of the following further conditions is satisfied, the UE can alternatively attempt to transmit S-SSB(s) in non-anchor RB-set(s) (not transmit S-SSB(s) in the anchor RB-set):
Condition 1: the anchor RB-set is not within the RB-set(s) associated with the resource pool;
Condition 2: the non-anchor RB-set(s) are within the RB-set(s) associated with the resource pool;
Condition 3: the slot including the S-SSB transmission includes the common S-SSB transmission occasions (e.g., not the additional candidate S-SSB transmission occasions);
Condition 4: the slot for S-SSB(s) transmission is within a channel occupancy initiated by the UE (potentially with further sub-example applied according to the example of this disclosure). For instance, SL transmission (e.g., PSSCH/PSCCH and/or PSFCH) can occur right before the slot for S-SSB(s) transmission.
Condition 5: the non-anchor RB-set(s) for S-SSB(s) transmission is within a channel occupancy initiated by the UE (potentially with further sub-example applied according to the example of this disclosure). For instance, SL transmission (e.g., PSSCH/PSCCH and/or PSFCH) can occur in the non-anchor RB-set(s).
Condition 6: the channel access procedure for transmit S-SSB(s) on the channel that includes the anchor RB-set fails. For instance, the channel access procedure can be one of a Type 1 SL channel access procedure or a Type 2A SL channel access procedure (when the duty cycle and duration satisfy the condition as in the example of this disclosure).

For yet another example, the UE at least attempts to transmit S-SSB(s) in the anchor RB-set and in the slot(s) including the common S-SSB transmission occasions; when at least one of the following further conditions is satisfied, the UE can alternatively attempt to transmit S-SSB(s) in non-anchor RB-set(s) (not transmit S-SSB(s) in the anchor RB-set):
Condition 1: the anchor RB-set is not within the RB-set(s) associated with the resource pool;
Condition 2: the non-anchor RB-set(s) are within the RB-set(s) associated with the resource pool;
Condition 3: the slot including the S-SSB transmission includes the additional candidate S-SSB transmission occasions (e.g., not the common S-SSB transmission occasions); and/or
Condition 4: the slot for S-SSB(s) transmission is within a channel occupancy initiated by the UE (optionally with further sub-example applied according to the example of this disclosure). For instance, SL transmission (e.g., PSSCH/PSCCH and/or PSFCH) can occur right before the slot for S-SSB(s) transmission.
Condition 5: the non-anchor RB-set(s) for S-SSB(s) transmission is within a channel occupancy initiated by the UE (potentially with further sub-example applied according to the example of this disclosure). For instance, SL transmission (e.g., PSSCH/PSCCH and/or PSFCH) can occur in the non-anchor RB-set(s).
Condition 6: the channel access procedure for transmit S-SSB(s) on the channel that includes the anchor RB-set fails. For instance, the channel access procedure can be one of a Type 1 SL channel access procedure or a Type 2A SL channel access procedure (when the duty cycle and duration satisfy the condition as in the example of this disclosure).

For yet another example, when at least one of the following further conditions is satisfied, the UE can attempt to transmit S-SSB(s) in non-anchor RB-set(s) (not transmit S-SSB(s) in the anchor RB-set); otherwise, the UE at least attempts to transmit S-SSB(s) in the anchor RB-set and in the slot(s) including the common S-SSB transmission occasions:
Condition 1: the anchor RB-set is not within the RB-set(s) associated with the resource pool;
Condition 2: the non-anchor RB-set(s) are within the RB-set(s) associated with the resource pool;
Condition 3: the slot including the S-SSB transmission includes the common S-SSB transmission occasions (e.g., not the additional candidate S-SSB transmission occasions); and/or
Condition 4: the slot for S-SSB(s) transmission is within a channel occupancy initiated by the UE (optionally with further sub-example applied according to the example of this disclosure). For instance, SL transmission (e.g., PSSCH/PSCCH and/or PSFCH) can occur right before the slot for S-SSB(s) transmission.
Condition 5: the non-anchor RB-set(s) for S-SSB(s) transmission is within a channel occupancy initiated by the UE (potentially with further sub-example applied according to the example of this disclosure). For instance, SL transmission (e.g., PSSCH/PSCCH and/or PSFCH) can occur in the non-anchor RB-set(s).
Condition 6: the channel access procedure for transmit S-SSB(s) on the channel that includes the anchor RB-set fails. For instance, the channel access procedure can be one of a Type 1 SL channel access procedure or a Type 2A SL channel access procedure (when the duty cycle and duration satisfy the condition as in the example of this disclosure).

For yet another example, when at least one of the following further conditions is satisfied, the UE can attempt to transmit S-SSB(s) in non-anchor RB-set(s) (not transmit S-SSB(s) in the anchor RB-set); otherwise, the UE at least attempts to transmit S-SSB(s) in the anchor RB-set and in the slot(s) including the common S-SSB transmission occasions:
Condition 1: the anchor RB-set is not within the RB-set(s) associated with the resource pool;
Condition 2: the non-anchor RB-set(s) are within the RB-set(s) associated with the resource pool;
Condition 3: the slot including the S-SSB transmission includes the additional candidate S-SSB transmission occasions (e.g., not the common S-SSB transmission occasions); and/or
Condition 4: the slot for S-SSB(s) transmission is within a channel occupancy initiated by the UE (optionally with further sub-example applied according to the example of this disclosure). For instance, SL transmission (e.g., PSSCH/PSCCH and/or PSFCH) can occur right before the slot for S-SSB(s) transmission.
Condition 5: the non-anchor RB-set(s) for S-SSB(s) transmission is within a channel occupancy initiated by the UE (potentially with further sub-example applied according to the example of this disclosure). For instance, SL transmission (e.g., PSSCH/PSCCH and/or PSFCH) can occur in the non-anchor RB-set(s).
Condition 6: the channel access procedure for transmit S-SSB(s) on the channel that includes the anchor RB-set fails. For instance, the channel access procedure can be one of a Type 1 SL channel access procedure or a Type 2A SL channel access procedure (when the duty cycle and duration satisfy the condition as in the example of this disclosure).

The above flowchart illustrates an example method that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Any of the above variation embodiments can be utilized independently or in combination with at least one other variation embodiment.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a transceiver configured to receive a set of configurations; and
a processor operably coupled to the transceiver, the processor configured to:
determine, based on the set of configurations, a sidelink (SL) bandwidth part (BWP);
determine, based on the set of configurations, a resource pool in the SL BWP;
determine, based on the set of configurations, a number of resource block (RB) sets in the SL BWP, wherein the number of RB sets include one anchor RB set and one or more non-anchor RB sets; and
determine, based on the set of configurations, a slot for a transmission of a sidelink synchronization signals and physical sidelink broadcast channel (S-SS/PSBCH) block,
wherein the transceiver is further configured to:
attempt to transmit the S-SS/PSBCH block in the slot and at least in the anchor RB set, wherein a channel access procedure is performed on a channel that includes the anchor RB set; and
attempt to transmit the S-SS/PSBCH block in the slot and in the one or more non-anchor RB sets only when the channel access procedure fails.

2. The UE of claim 1, wherein the one or more non-anchor RB sets is associated with the resource pool.

3. The UE of claim 1, wherein the slot is determined from one of a first set of slots or a second set of slots.

4. The UE of claim 3, wherein:
an index of a slot in the first set of slots is given by N_{offset}^{S-SSB}+(Nᵢₙₜₑᵣᵥₐₗ^{S-SSB}+1)·i_{S-SSB};
an index 0 corresponds to a first slot in a frame with a system frame number (SFN) of a serving cell satisfying (SFN mod 16)=0 or a direct frame number (DFN) satisfying (DFN mod 16)=0;
i_{S-SSB} is a S-SS/PSBCH block index within a number of S-SS/PSBCH blocks in a period, where 0≤i_{S-SSB}≤N_{period}^{S-SSB}−1 and N_{period}^{S-SSB} is provided by the set of configurations;
N_{offset}^{S-SSB} is a slot offset from a start of the period to a first slot including a S-SS/PSBCH block, provided by the set of configurations; and
Nᵢₙₜₑᵣᵥₐₗ^{S-SSB} is a slot interval between S-SS/PSBCH blocks, provided by the set of configurations.

5. The UE of claim 4, wherein:
the second set of slots are additional candidate S-SS/PSBCH block transmission occasions, and an index of a slot in the second set of slots is given by N_{offset}^{S-SSB}+(Nᵢₙₜₑᵣᵥₐₗ^{S-SSB}+1)·i_{S-SSB}+(N_{gap}^{S-SSB}+1)·(ī_{S-SSB}+1),
N_{gap}^{S-SSB} is a slot gap for determining the additional candidate S-SS/PSBCH block transmission occasions and is provided by the set of configurations, and
ī_{S-SSB} is an index of the additional candidate S-SS/PSBCH block transmission occasions, where 0≤ī_{S-SSB}≤N_{additional}^{S-SSB}−1 and N_{additional}^{S-SSB} is provided by the set of configurations.

6. The UE of claim 1, wherein the processor is further configured to:
determine a first power allocated for an S-SS/PSBCH block in the anchor RB set; and
determine a second power allocated for an S-SS/PSBCH block in the one or more non-anchor RB sets.

7. The UE of claim 6, wherein the first power is same for all S-SS/PSBCH blocks in the anchor RB set.

8. The UE of claim 6, wherein the second power is same for all S-SS/PSBCH blocks in all the one or more non-anchor RB sets.

9. The UE of claim 6, wherein the processor is further configured to:
determine a first total power for all S-SS/PSBCH blocks in the anchor RB set;
determine a remaining power as a maximum transmission power (P_{CMAX}) minus the first total power; and
determine a second total power for all S-SS/PSBCH blocks in the one or more non-anchor RB sets as the remaining power when the remaining power is positive.

10. The UE of claim 1, wherein the processor is further configured to:
determine that at least one of:
the anchor RB set is not associated with the resource pool;
the slot is within a channel occupancy initiated by the UE; and
the one or more non-anchor RB sets is within the channel occupancy initiated by the UE.

11. A method of a user equipment (UE) in a wireless communication system, the method comprising:
receiving a set of configurations;
determining, based on the set of configurations, a sidelink (SL) bandwidth part (BWP);
determining, based on the set of configurations, a resource pool in the SL BWP;
determining, based on the set of configurations, a number of resource block (RB) sets in the SL BWP, wherein the number of RB sets include one anchor RB set and one or more non-anchor RB sets;
determining, based on the set of configurations, a slot for a transmission of a sidelink synchronization signals and physical sidelink broadcast channel (S-SS/PSBCH) block;
attempting to transmit the S-SS/PSBCH block in the slot and at least in the anchor RB set, wherein a channel access procedure is performed on a channel that includes the anchor RB set; and
attempting to transmit the S-SS/PSBCH block in the slot and in the one or more non-anchor RB sets only when the channel access procedure fails.

12. The method of claim 11, wherein the one or more non-anchor RB sets is associated with the resource pool.

13. The method of claim 11, wherein the slot is determined from one of a first set of slots or a second set of slots.

14. The method of claim 13, wherein:
an index of a slot in the first set of slots is given by N_{offset}^{S-SSB}+(Nᵢₙₜₑᵣᵥₐₗ^{S-SSB}+1)·i_{S-SSB};
an index 0 corresponds to a first slot in a frame with a system frame number (SFN) of a serving cell satisfying (SFN mod 16)=0 or a direct frame number (DFN) satisfying (DFN mod 16)=0;
i_{S-SSB} is a S-SS/PSBCH block index within a number of S-SS/PSBCH blocks in a period, where 0≤i_{S-SSB}≤N_{period}^{S-SSB}−1 and N_{period}^{S-SSB} is provided by the set of configurations;
N_{offset}^{S-SSB} is a slot offset from a start of the period to a first slot including a S-SS/PSBCH block, provided by the set of configurations; and
Nᵢₙₜₑᵣᵥₐₗ^{S-SSB} is a slot interval between S-SS/PSBCH blocks, provided by the set of configurations.

15. The method of claim 14, wherein:
the second set of slots are additional candidate S-SS/PSBCH block transmission occasions, and an index of a slot in the second set of slots is given by N_{offset}^{S-SSB}+(Nᵢₙₜₑᵣᵥₐₗ^{S-SSB}+1)·i_{S-SSB}+(N_{gap}^{S-SSB}+1)·(ī_{S-SSB}+1),
N_{gap}^{S-SSB} is a slot gap for determining the additional candidate S-SS/PSBCH block transmission occasions and is provided by the set of configurations, and
ī_{S-SSB} is an index of the additional candidate S-SS/PSBCH block transmission occasions, where 0≤ī_{S-SSB}≤N_{additional}^{S-SSB}−1 and N_{additional}^{S-SSB} is provided by the set of configurations.

16. The method of claim 11 further comprising:
determining a first power allocated for an S-SS/PSBCH block in the anchor RB set; and
determining a second power allocated for an S-SS/PSBCH block in the one or more non-anchor RB sets.

17. The method of claim 16, wherein the first power is same for all S-SS/PSBCH blocks in the anchor RB set.

18. The method of claim 16, wherein the second power is same for all S-SS/PSBCH blocks in all the one or more non-anchor RB sets.

19. The method of claim 16 further comprising:
determining a first total power for all S-SS/PSBCH blocks in the anchor RB set;
determining a remaining power as a maximum transmission power (P_{CMAX}) minus the first total power; and
determining a second total power for all S-SS/PSBCH blocks in the one or more non-anchor RB sets as the remaining power when the remaining power is positive.

20. The method of claim 11 further comprising:
determining that at least one of:
the anchor RB set is not associated with the resource pool;
the slot is within a channel occupancy initiated by the UE; and
the one or more non-anchor RB sets is within the channel occupancy initiated by the UE.
